(19) United States
(12) Patent Application Publication
(10) Pub. No.: US 2014/0310674 A1
(43) Pub. Date: Oct. 16, 2014

(54) SYSTEM AND METHOD FOR CHECKING SIGNAL TRANSMISSION LINE

(71) Applicants: Hon Hai Precision Industry Co., Ltd., New Taipei (TW); Hong Fu Jin Precision Industry (ShenZhen) Co., Ltd., Shenzhen (CN)

(72) Inventors: YA-LING HUANG, Shenzhen (CN); CHIA-NAN PAI, Tu-Cheng (TW); SHOU-KUO HSU, Tu-Cheng (TW)

(73) Assignees: Hon Hai Precision Industry Co., Ltd., New Taipei (TW); Hong Fu Jin Precision Industry (ShenZhen) Co., Ltd., Shenzhen (TW)

(21) Appl. No.: 13/968,386

(22) Filed: Aug. 15, 2013

(30) Foreign Application Priority Data
Apr. 15, 2013 (CN) 2013101275670

(51) Int. Cl. G06F 17/50

(52) U.S. Cl. CPC G06F 17/5081
USPC 716/136

(57) ABSTRACT

A computer-based method for checking signal transmission lines of a printed circuit board (PCB) layout is provided. A design rules is set according to different length requirements and the quantity of storage devices input by users. A group of transmission line from a displayed PCB layout is selected. The quantity of branch lines of each transmission line to be checked and the length of each branch line of the group of transmission lines to be checked are computed. The design of which branch lines does not satisfy the design rules is determined according to the computed quantity of the branch lines of each transmission line to be checked, the length of each branch line of the group of transmission lines, and the design rules.

### BACKGROUND

1. Technical Field

Embodiments of the present disclosure relates to circuit simulating systems and methods, and more particularly, to a system and a method for checking the length of branch lines of Double Data Rate (DDR) transmission lines in a printed circuit board (PCB) layout.

2. Description of Related Art

In a PCB layout, each of DDR transmission lines includes a quantity of branch lines. Each branch line should satisfy design rules. However, checking whether the branch lines of DDR transmission lines satisfy the design rules is often done visually by a technician, which is not only time-consuming, but also error-prone.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of one embodiment of a computing device for checking signal transmission lines of a PCB layout.

FIG. 2 is a block diagram of one embodiment of function modules of a check system in the computing device of FIG. 1.

FIG. 3 is a schematic view of DDR transmission lines.

FIG. 4 is a flowchart of one embodiment of a method for checking signal transmission lines of a PCB layout.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

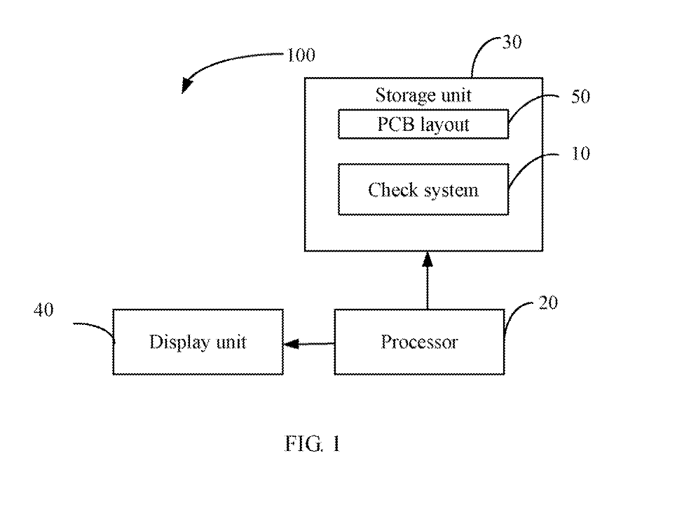

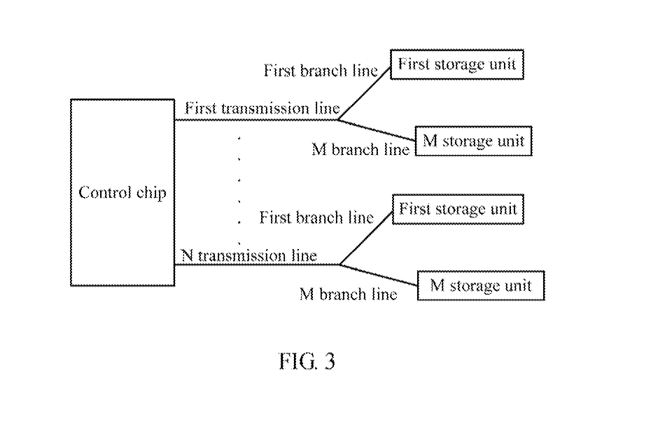

FIG. 1 is a block diagram of one embodiment of a computing device 10. The computing device 10 includes a processor 20, a storage unit 30, and a display unit 40. The storage unit 30 may be a computer, a smart media card, a secure digital card, or a flash card. The storage unit 30 stores computerized codes of a check system 10 and at least one PCB layout 50. The check system 10 includes various software components and/or a set of instructions, which may be implemented by the processor 20 to check the length of signal transmission lines. In this embodiment, the check system 10 is implemented by the processor 20 to check the length of branch lines of DDR transmission lines. Each DDR transmission line includes an intersection point, and one end of each branch line of the DDR transmission line is connected to the intersection point, and another end of each branch line is connected to a storage device (see FIG. 3).

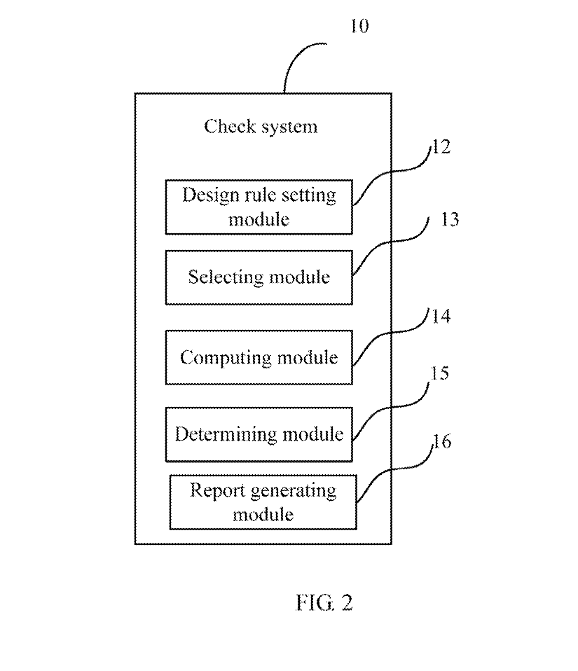

FIG. 2 is a block diagram of the function modules of the check system 10 in the computing device 100 of FIG. 1. In one embodiment, the check system 10 includes a design rules setting module 12, a selecting module 13, a computing module 14, a determining module 15, and a report generating module 16.

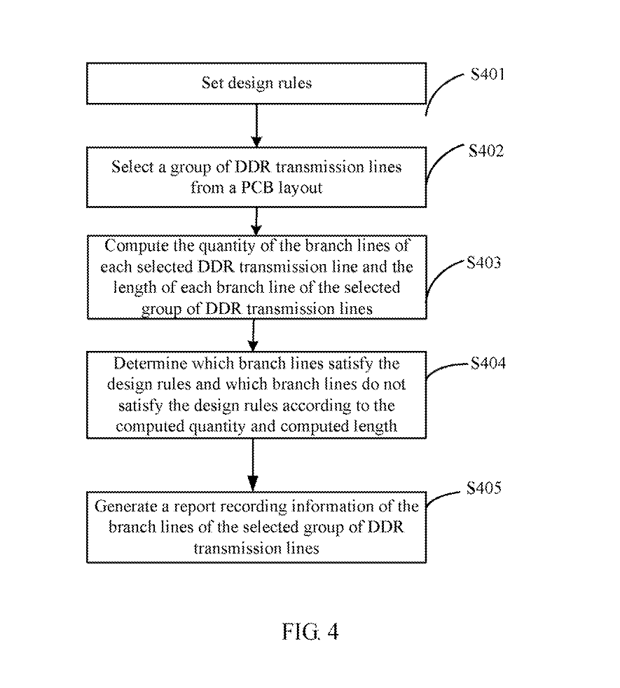

FIG. 4 is a flowchart of a method for checking signal transmission lines, in accordance with an exemplary embodiment.

In step S401, the design rules setting module 12 sets design rules according to different length requirements and the quantity of storage devices input by users. In the design rules, the length of each branch line of each DDR transmission line falls within a first range. The difference between the longest branch line and the shortest branch line of each DDR transmission line falls within a second range. In a group of DDR transmission lines, the distance between the longest branch line and the shortest branch line of the branch lines connected to the same storage device falls within a third range. As shown in FIG. 3, the transmission line first through eighth are in a group. The length of the first branch line and the second branch line of the first transmission line falls within the first range, and the difference between the first branch line and the second branch line of the first transmission line falls within the second range. The difference between the longest branch line and the shortest branch line of the first branch lines of the first transmission line, . . . , and the eighth transmission falls within the third range. Furthermore, in the design rules, the quantity of the branch lines of each DDR transmission line is the same as the input quantity of storage devices.

In step S402, the selecting module 13 selects a group of DDR transmission lines from a PCB layout 50 displayed on the display unit 40 according to input names of transmission lines to be checked and an input name of a chipset connected to the transmission lines to be checked.

In step S403, the computing module 14 computes the quantity of the branch lines of each selected DDR transmission line and the length of each branch line of the selected group of DDR transmission lines.

In step S404, the determining module 15 determines which branch lines satisfy the design rules and which branch lines do not satisfy the design rules according to the computed quantity of the branch lines of each selected DDR transmission line, the length of each branch line of the selected group of DDR transmission lines, and the design rules.

In step S405, the report generating module 16 generates a report recording information of the branch lines of the selected group of DDR transmission lines, for example, the length of the branch lines, and the design rules corresponding to each branch line. From the report, designers can easily find out which branch lines satisfy design rules and which branch lines do not satisfy design rules.

Although certain inventive embodiments of the present disclosure have been specifically described, the present disclosure is not to be construed as being limited thereto. Various changes or modifications may be made to the present disclosure without departing from the scope and spirit of the present disclosure.

1. A computer-based method for checking signal transmission lines of a printed circuit board (PCB) layout, the method comprising:
setting design rules by a processor according to different length requirements and a quantity of storage devices input by users, wherein in the design rules, the length of each branch line of each transmission line falls within a first range, the difference between the longest branch line and the shortest branch line of each transmission line falls within a second range, and in a group of transmission lines, the distance between the longest branch line and the shortest branch line of the branch lines connected to a same one of the storage devices falls within a third range, the quantity of the branch lines of each transmission line is the same as the input quantity of storage devices;
selecting a group of transmission line from a displayed PCB layout according to input names of transmission lines to be checked and an input name of a chipset connected to the transmission lines to be checked by the processor;
computing the quantity of branch lines of each selected transmission line and the length of each branch line of the selected group of transmission lines by the processor; and
determining the branch lines satisfy the design rules by the processor if the length of the branch lines fall within the first range, the difference between the longest branch line and the shortest branch line of each transmission line falls within the second range, and the distance between the longest branch line and the shortest branch line of the branch lines connected to the same of the storage device falls within the third range, and the quantity of the branch lines of each transmission line is the same as the input quantity of storage devices, and determining the branch lines do not satisfy the design rules by the processor if the length of the branch lines do not fall within the first range, the difference between the longest branch line and the shortest branch line of each transmission line does not fall within the second range, or the distance between the longest branch line and the shortest branch line of the branch lines connected to the same of the storage device does not fall within the third range, or the quantity of the branch lines of each transmission line is the same as the input quantity of storage devices.

2. The method as claimed in claim 1, further comprising:
generating a report recording information of the branch lines which do not satisfy the design rules.

3. The method as described in claim 2, further comprising:
generating a report recording information of the branch lines which satisfy the design rules.

4. A system comprising:
one or more computing devices; and
one or more computer-readable media coupled to the one or more computing devices and having instructions stored thereon which, when executed by the one or more computing devices, cause the one or more computing devices to perform operations for checking signal transmission lines, the operations comprising:
setting design rules according to different length requirements and a quantity of storage devices input by users, wherein in the design rules, the length of each branch line of each transmission line falls within a first range, the difference between the longest branch line and the shortest branch line of each transmission line falls within a second range, and in a group of transmission lines, the distance between the longest branch line and the shortest branch line of the branch lines connected to a same one of the storage devices falls within a third range, the quantity of the branch lines of each transmission line is the same as the input quantity of storage devices;
selecting a group of transmission line from a displayed PCB layout according to input names of transmission lines to be checked and an input name of a chipset connected to the transmission lines to be checked;
computing the quantity of branch lines of each selected transmission line and the length of each branch line of the selected group of transmission lines; and
determining the branch lines satisfy the design rules if the length of the branch lines fall within the first range, the difference between the longest branch line and the shortest branch line of each transmission line falls within the second range, and the distance between the longest branch line and the shortest branch line of the branch lines connected to the same of the storage device falls within the third range, and the quantity of the branch lines of each transmission line is the same as the input quantity of storage devices, and determining the branch lines do not satisfy the design rules if the length of the branch lines do not fall within the first range, the difference between the longest branch line and the shortest branch line of each transmission line does not fall within the second range, or the distance between the longest branch line and the shortest branch line of the branch lines connected to the same of the storage device does not fall within the third range, or the quantity of the branch lines of each transmission line is the same as the input quantity of storage devices.

5. The system as described in claim 4, wherein the operations further comprising: generating a report recording information of the branch lines which do not satisfy the design rules.

6. The system as described in claim 5, wherein the operations further comprising:
generating a report recording information of the branch lines which satisfy the design rules.

7. A non transitory computer storage medium encoded with a computer program, the program comprising instructions that when executed by one or more computers cause the one or more computers to perform operations comprising:
setting design rules according to different length requirements and a quantity of storage devices input by users, wherein in the design rules, the length of each branch line of each transmission line falls within a first range, the difference between the longest branch line and the shortest branch line of each transmission line falls within a second range, and in a group of transmission lines, the distance between the longest branch line and the shortest branch line of the branch lines connected to a same one of the storage devices falls within a third range, the quantity of the branch lines of each transmission line is the same as the input quantity of storage devices;
selecting a group of transmission line from a displayed PCB layout according to input names of transmission lines to be checked and an input name of a chipset connected to the transmission lines to be checked;
computing the quantity of branch lines of each selected transmission line and the length of each branch line of the selected group of transmission lines; and
determining the branch lines satisfy the design rules if the length of the branch lines fall within the first range, the difference between the longest branch line and the shortest branch line of each transmission line falls within the second range, and the distance between the longest branch line and the shortest branch line of the branch lines connected to the same of the storage device falls within the third range, and the quantity of the branch lines of each transmission line is the same as the input quantity of storage devices, and determining the branch lines do not satisfy the design rules if the length of the branch lines do not fall within the first range, the difference between the longest branch line and the shortest branch line of each transmission line does not fall within the second range, or the distance between the longest branch line and the shortest branch line of the branch lines connected to the same of the storage device does not fall within the third range, or the quantity of the branch lines of each transmission line is the same as the input quantity of storage devices.

8. The storage medium as described in claim 7, wherein the operations further comprising:
generating a report recording information of the branch lines which do not satisfy the design rules.

9. The computer storage medium as described in claim 8, wherein the operations further comprising:
generating a report recording information of the branch lines which satisfy the design rules.
